(19) United States
(12) Patent Application Publication
(10) Pub. No.: US 2013/0014477 A1
(43) Pub. Date: Jan. 17, 2013

(54) Saddle Pad

(71) Applicant: Janet Amy Wollowick, Hollywood, FL (US)

(72) Inventor: Janet Amy Wollowick, Hollywood, FL (US)

(21) Appl. No.: 13/181,297

(22) Filed: Jul. 12, 2011

(51) Int. Cl. B68C 1/12; B68C 1/08

(52) U.S. Cl. 54/66

(57) ABSTRACT

A saddle pad is described for placement on a horse or other riding animal's back. The saddle pad can include a pad and an outer cover into which the pad is inserted. The saddle pad is placed directly on the back of the animal and a saddle is placed on top of and over the saddle pad. The pad can be constructed from one, two, or more pieces of material and includes one or more cushioning elements. One of the cushioning elements can be located along a central longitudinal axis of the pad. The cushioning elements of the pad can be constructed from walls, baffles, or bladders, which may be filled with a gas, a liquid, or a gel material to increase stability of the saddle pad and to provide additional cushioning between the saddle and the animal's back as well as between the rider and the saddle.

### FIELD OF THE INVENTION

The invention relates to riding animals. More particularly, the invention relates to a protective apparatus that can be worn over the back and under the saddle of a riding animal.

### BACKGROUND

Horses and other riding animals often suffer from injury and stress to their backs. Physical injuries and stresses occur as the animals walk and run with a mounted rider on a saddle. The force of weight of the rider and saddle are directed downward directly onto the back of the riding animal. Injuries may be caused by the repeated forceful impact of a rider and saddle on animal's back. Injuries may also be caused by saddle pressure if the horse is ridden for long periods of time. Treatment of these injuries can be costly for the owner and may lead to more serious illness or death of the animal. In an effort to protect from these injuries, a saddle pad may be provided for riding animals to cushion the impact of the saddle onto their back during movement.

Riders of horses and other riding animals may also suffer from pain, discomfort, bruising, or other injuries due to the bouncing and jolting movements experienced when riding. Riding a horse for long hours can also have negative impacts on the rider's posture.

Conventional saddle pads are constructed from quilted material that inadequately protects the back of the riding animal, while providing little or no benefit to the comfort of the rider. Conventional saddle pads also lack features to reduce muscle fatigue experienced by riding animals during riding or to cool the animal to prevent heat fatigue or exhaustion. Such saddle pads also do not distribute the weight of the rider and saddle evenly on the animal's back and do not permit the animal's perspiration to evaporate but instead cause the perspiration to accumulate beneath the pad, which increases the risk of bacterial and fungal infections on the animal's skin.

A need exists for a saddle pad that provides comfort and protection both to a riding animal and its rider.

### SUMMARY

A saddle pad is provided that features a double-ply fabric or material casing with baffles or bladders inside. The saddle pad can be used by a consumer to provide for protection and cushioning of a riding animal's back. The saddle pad can be placed directly on a riding animal's back. Once the saddle pad is fitted over the back, the animal can be fitted with a saddle. The saddle pad can be constructed from a variety of durable fabrics or materials.

In one embodiment, the saddle pad can feature one or more baffles or bladders being air-filled; gel-filled; liquid-filled; or one or more inner layers of soft material attached to an inner surface of the saddle pad.

In another embodiment, the saddle pad can be detachably connected to the saddle using one or more fasteners.

One advantage of the saddle pad is the protection afforded to the riding animal's back and spine. During riding, mechanical stresses such as the friction and weight of and between a riding animal's back and the saddle and rider can cause skin irritation, hair loss, bruising, and discomfort to the animal. Using the saddle pad, the negative impact of riding on the animal can be diminished as the animal's back is protected and cushioned from the weight and friction of the saddle and rider.

Another advantage of the saddle pad is that usage of the saddle pad enhances the comfort of the rider during riding. The saddle pad can be beneficial for the posture of the rider, to prevent injury to the rider by jolting or other movement of the animal during riding, and to provide additional comfort to a rider who has a pre-existing injury in the legs, thighs, buttocks, or back.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

Accordingly, the invention features a saddle pad for placing on a back of a riding animal beneath a saddle. The saddle pad includes a pad, at least one cushioning element installed inside the pad, and an outer cover.

In another aspect, the invention can feature the pad including a single piece of material and the at least one cushioning element can be constructed as an integral part of the single piece of material.

In another aspect, the invention can feature the single piece of material defining an interior space.

In another aspect, the invention can feature the pad including two pieces of material connected together to define an interior space.

In another aspect, the invention can feature the at least one cushioning element being installed inside the interior space.

In another aspect, the invention can feature the at least one cushioning element including one or more baffles constructed between inner surfaces of the two pieces of material comprising the pad.

In another aspect, the invention can feature the at least one cushioning element including one or more walls constructed between inner surfaces of the two pieces of material comprising the pad.

In another aspect, the invention can feature the at least one cushioning element including one or more bladders installed in the interior space between inner surfaces of the two pieces of material comprising the pad.

In another aspect, the invention can feature the cushioning element including a gas filling.

In another aspect, the invention can feature the cushioning element including a gel filling.

In another aspect, the invention can feature the cushioning element including a liquid filling.

In another aspect, the invention can feature each piece of material including an inner surface, wherein one or more layers of soft material are attached to each inner surface.

In another aspect, the invention can feature the outer cover including an open end and an interior space into which the pad is inserted.

In another aspect, the invention can feature the outer cover being constructed from cotton, wool, hemp, silk, nylon, spandex, polyester, acrylic, neoprene or other waterproof materials, fleece, a combination of one or more of these materials, or any other suitable fabric or material.

In another aspect, the invention can feature the open end of the outer cover being closable by a fastener. The fastener can be one or more buckles, buttons, snaps, clips, hook-and-loop fasteners, or any other suitable fastener.

In another aspect, the invention can feature the open end of the outer cover being closable by a fastener that is a zipper.

In another aspect, the invention can feature the pad including a centerline cushioning element positioned at a central longitudinal axis of the pad.

In another aspect, the invention can feature the outer cover including quilting.

In another aspect, the invention can feature the pad and outer cover including slip-resistance and anti-bacterial and anti-fungal properties.

The invention can also feature a cushioning apparatus for placing on a back of a riding animal beneath a saddle to protect and provide comfort to both the riding animal and a rider. The cushioning apparatus can include a pad having at least one cushioning element installed thereon, and the cushioning element can feature a fluid filling.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a side view of a pad of the saddle pad with a plurality of vertically oriented cushioning elements.

FIG. 2 is a front view of the pad of FIG. 1.

FIG. 3 is a side view of a pad of the saddle pad with a plurality of horizontally oriented cushioning elements.

FIG. 4 is a front view of the pad of FIG. 3.

FIG. 5 is a side view of a pad of the saddle pad with a plurality of horizontally oriented cushioning elements including a centerline cushioning element.

FIG. 6 is a front view of the pad of FIG. 5.

FIG. 7 is a side view of an outer cover of the saddle pad.

### DETAILED DESCRIPTION

Several embodiments of a saddle pad or cushioning apparatus 10 for protecting and supporting a riding animal's back are described. While various embodiments of the saddle pad 10 can be used with almost any animal, the apparatus is ideal for protecting and supporting the backs of riding animals and of horses in particular. Other riding animals with which the saddle pad 10 may be used include donkeys, mules, ponies, and camels. The saddle pad 10 may also be placed upon a back of a pack animal used to carry loads so as to provide similar protection and comfort for the pack animal as when the apparatus is used with a riding animal. Pack animals with which the saddle pad 10 may be used include horses, donkeys, mules, camels, cattle and other bovine animals, llamas, reindeer, and yaks. For purposes of example only and not by way of limitation, the invention is described hereinafter with reference to a horse as the riding animal.

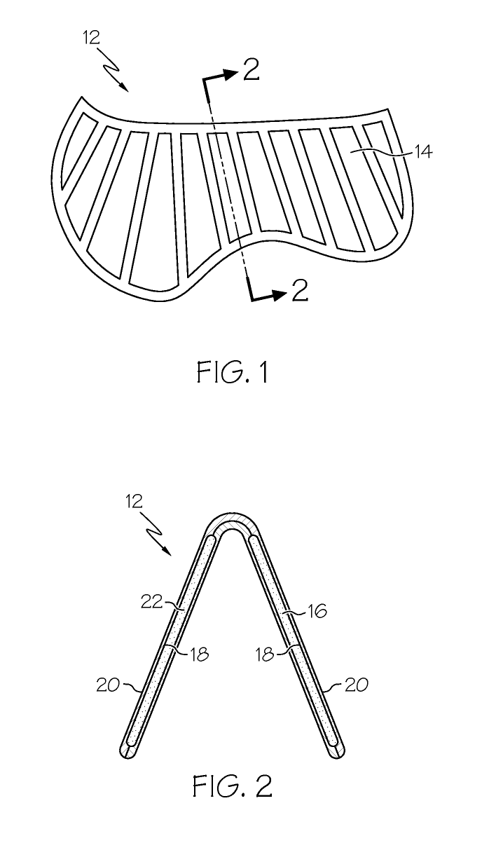

As shown in FIGS. 1-6, the saddle pad 10 includes a pad 12 and at least one cushioning element 14. The pad 12 can be constructed from a single piece of material that is constructed to define an interior space 16 in which the cushioning elements 14 can be installed, as shown in FIG. 6. In other embodiments, the pad 12 can be constructed from one, two, three, or more pieces of material. Where the pad 12 is constructed from two pieces of material, as shown in FIGS. 2 and 4, the interior space 16 can be defined between the attached two pieces of material. In embodiments where the pad 12 is constructed from three, four, five, or more pieces of materials (e.g., arranged and secured together as plies), an interior space 16 may be defined between each adjacent pair of connected pieces of material, or a single interior space 16 may be formed between two adjacent connected pieces of material while the remaining connected pieces of material are layered closely together without leaving any space between them. With respect to exemplary embodiments of the saddle pad 10 having a pad 12 featuring two pieces of material, each piece of material includes an inner surface 18 and an outer surface 20. The inner surfaces 18 of the pieces of material face inward toward the interior space 16, while the outer surfaces 20 face outward and are exposed to the elements and physical contact.

The saddle pad 10 can feature a single cushioning element 14 or, in exemplary embodiments, a plurality of cushioning elements 14 installed on the pad 12. In an exemplary embodiment, the cushioning elements 14 can be installed in the interior space 16. In another embodiment, the cushioning elements 14 can be installed on the inner surface of two or more pieces of material forming the pad 12, while leaving the interior space 16 unblocked. In yet another embodiment, the cushioning elements 14 can be installed on the outer surfaces 20 of the pieces of material forming the pad 12. In still another embodiment, the interior space 16 and the inner surfaces 18 defining it can form the cushioning elements 14. In another embodiment, the cushioning elements can be formed or installed between one, two, three, or more plies of material in multi-ply embodiments of the pad 12.

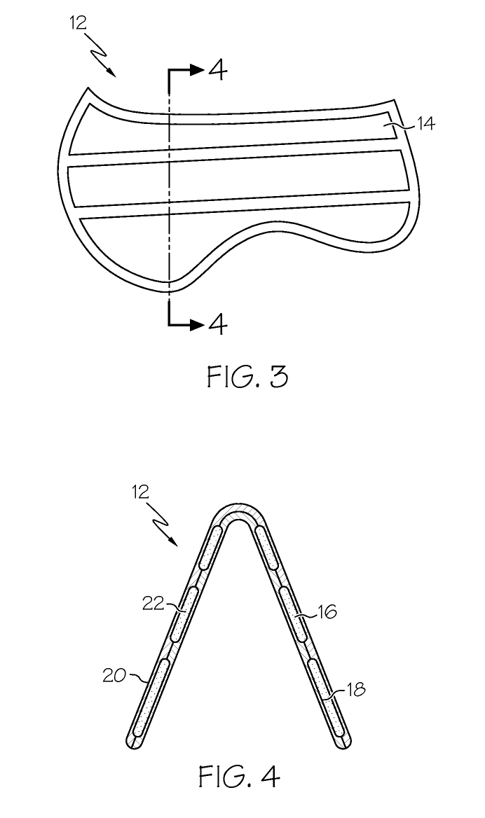

In some embodiments of the saddle pad 10, the cushioning elements 14 can be arranged and installed in the pad 12 in generally vertical orientations as shown in FIGS. 1 and 2. In other embodiments of the saddle pad 10, the cushioning elements 14 can be arranged and installed in the pad 12 in generally horizontal orientations as shown in FIG. 3-6.

In one embodiment, the cushioning elements 14 can be bladders or sacs filled with a cushioning material 22. In another embodiment, the cushioning elements 14 can be walls constructed in the interior space 16 between the inner surfaces 18 of the piece or pieces of material forming the pad 12. In another embodiment, the cushioning elements 14 can be baffles constructed in the interior space 16 between the inner surfaces 18 of the piece or pieces of material forming the pad 12. In embodiments, where the cushioning elements 14 are walls or baffles, terminal ends of each wall or baffle can be permanently attached to the inner surface 18 of the adjacent piece of material of the pad 12. In embodiments where the pad 12 is created from two or more pieces of material, the cushioning elements 14 can be formed between the pieces of material, either as integral portions of the pieces of material or as separate components connected to and between each piece of material. The cushioning elements 14 provide a cushioning effect to both the horse and to its rider when the rider is mounted atop the horse.

The cushioning material 22 of the cushioning elements 14 can be a fluid such as, for example, a gas, a liquid, or a gel. Examples of some suitable gases include air, nitrogen, inert gases, and other non-pollutant gaseous blends. Examples of suitable liquids include water, alcohols, heat-absorbing liquids, and other safe, non-pollutant liquids. Gels suitable for use as the cushioning material 22 can be soft and durable or can be viscous, semi-liquid materials. Other suitable cushioning materials 22 include foams and soft stuffing materials such as, for example, cotton, wool, feathers, down, a synthetic stuffing such as polyester, any other suitable material exhibiting softness and good loft, or a combination of these materials

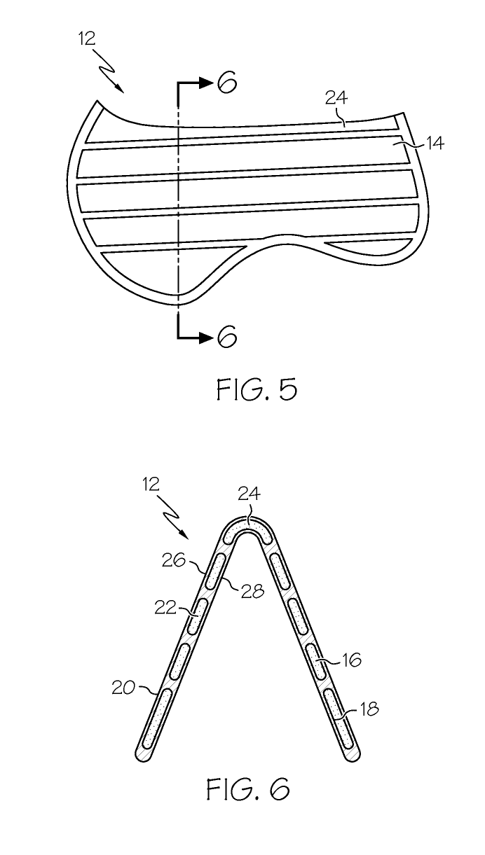

In an exemplary embodiment of the saddle pad 10 as shown in FIGS. 5 and 6, the pad can feature a centerline cushioning element 24 positioned at a central longitudinal axis of the pad and extending horizontally down all or part of the length of the pad longitudinally. The centerline cushioning element 24 forms a “cap” that can be fitted or positioned directly over the horse's spine to provide a greater cushioning effect in that area. The centerline cushioning element 24 may also include a greater amount of cushioning material 22 than the other cushioning elements 14 of the pad 12.

The pad 12 and its cushioning elements 14 can be made of a durable material such as a fabric or a polymer. For example, the pad 12 can be constructed from cotton, wool, hemp, nylon, spandex, polyester, acrylic, neoprene or other waterproof materials, a combination of one or more of these materials, or any other suitable fabric or material. The material may be semi-rigid or flexible. In another embodiment, the material of the pad 12 can be breathable and waterproof. The material of the cushioning elements 14 is generally waterproof and is not breathable due to need to retain fluid within the cushioning elements. In an exemplary embodiment, the material from which the pad 12 is constructed can be neoprene. In exemplary embodiments, the material of the pad 12 is also washable, for example, in a washing machine. The pad 12 can feature additional cushioning elements 14 installed on a top surface 26, on a bottom surface 28, or on both the top and bottom surfaces. The material from which the pad 12 and its cushioning elements 14 are instructed can feature slip-resistance and anti-bacterial and anti-fungal properties. In another embodiment, the material from which the pad 12 and its cushioning elements 14 are instructed can be coated or treated with chemicals that impart slip-resistance and anti-bacterial and anti-fungal properties to the material.

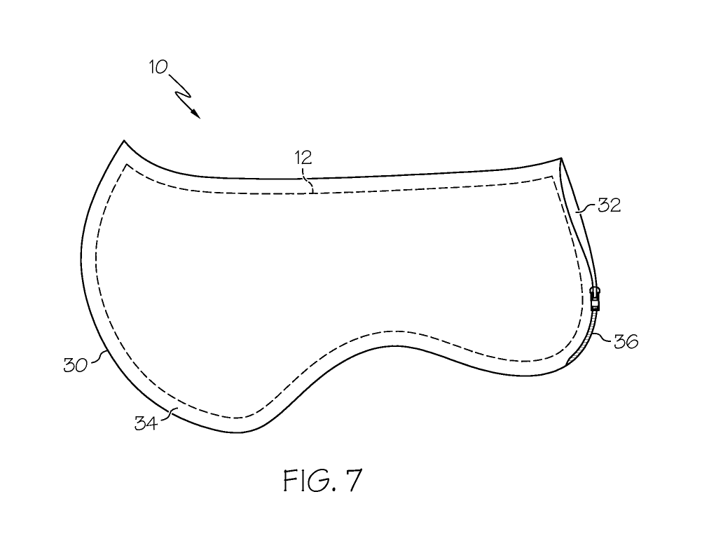

Optionally, although in an exemplary embodiment, the saddle pad 10 can also feature an outer cover 30 as illustrated in FIG. 7. The pad 12 is insertable through an open end 32 into an interior space 34 of the outer cover 30. The outer cover 30 can include a fastener 36 to close the open end 32 to secure and enclose the pad 12 inside the outer cover. In an exemplary embodiment, the fastener 36 can be one or more buckles, buttons, snaps, clips, hook-and-loop fasteners, or any other suitable fastener. In an exemplary embodiment, the fastener 36 is a zipper.

The outer cover 30 can be made of a durable material such as a natural fabric or a synthetic fabric or material, e.g., a polymer. For example, the outer cover 30 can be constructed from cotton, wool, hemp, silk, nylon, spandex, polyester, acrylic, a fleece material, neoprene or other waterproof materials, a combination of one or more of these materials, or any other suitable fabric or material. The material may be semi-rigid or flexible. In another embodiment, the material of the saddle can be breathable and waterproof. In an exemplary embodiment, the material from which the outer cover 30 is constructed can be neoprene. In exemplary embodiments, the material of the outer cover 30 is also washable, for example, in a washing machine, and may be dryable in a drying machine. In an alternative embodiment, the outer cover 30 may also feature additional cushioning elements 14 installed on its outer or inner surfaces. The material from which the outer cover 30 is instructed can feature slip-resistance and anti-bacterial and anti-fungal properties. In another embodiment, the material from which the outer cover 30 is instructed can be coated or treated with chemicals that impart slip-resistance and anti-bacterial and anti-fungal properties to the material.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A saddle pad for placing on a back of a riding animal beneath a saddle, the saddle pad comprising: a pad, at least one cushioning element installed inside the pad, and an outer cover.

2. The saddle pad of claim 1, wherein the pad comprises a single piece of material and wherein the at least one cushioning element is constructed as an integral part of the single piece of material.

3. The saddle pad of claim 2, wherein the single piece of material defines an interior space.

4. The saddle pad of claim 1, wherein the pad comprises two pieces of material connected together to define an interior space.

5. The saddle pad of claim 4, wherein the at least one cushioning element is installed inside the interior space.

6. The saddle pad of claim 5, wherein the at least one cushioning element comprises one or more baffles constructed between inner surfaces of the two pieces of material comprising the pad.

7. The saddle pad of claim 5, wherein the at least one cushioning element comprises one or more walls constructed between inner surfaces of the two pieces of material comprising the pad.

8. The saddle pad of claim 5, wherein the at least one cushioning element comprises one or more bladders installed in the interior space between inner surfaces of the two pieces of material comprising the pad.

9. The saddle pad of claim 5, wherein the cushioning element comprises a gas filling.

10. The saddle pad of claim 5, wherein the cushioning element comprises a gel filling.

11. The saddle pad of claim 5, wherein the cushioning element comprises a liquid filling.

12. The saddle pad of claim 4, wherein each piece of material comprises an inner surface, wherein one or more layers of soft material are attached to each inner surface.

13. The saddle pad of claim 1, wherein the outer cover comprises an open end and an interior space into which the pad is inserted.

14. The saddle pad of claim 13, wherein the outer cover comprises cotton, wool, hemp, silk, nylon, spandex, polyester, acrylic, neoprene or other waterproof materials, fleece, a combination of one or more of these materials, or any other suitable fabric or material.

15. The saddle pad of claim 13, wherein the open end of the outer cover is closable by a fastener, wherein the fastener is one or more buckles, buttons, snaps, clips, hook-and-loop fasteners, or any other suitable fastener.

16. The saddle pad of claim 13, wherein the open end of the outer cover is closable by a fastener, wherein the fastener is a zipper.

17. The saddle pad of claim 13, wherein the pad comprises a centerline cushioning element positioned at a central longitudinal axis of the pad.

18. The saddle pad of claim 13, wherein the outer cover comprises quilting.

19. The saddle pad of claim 13, wherein the pad and outer cover comprise slip-resistance and anti-bacterial and anti-fungal properties.

20. A cushioning apparatus for placing on a back of a riding animal beneath a saddle to protect and provide comfort to both the riding animal and a rider, the cushioning apparatus comprising: a pad comprising at least one cushioning element installed thereon, wherein the cushioning element comprises a fluid filling.
